(19) United States
(12) Patent Application Publication
(10) Pub. No.: US 2003/0057398 A1
(43) Pub. Date: Mar. 27, 2003

(54) Double salt of ammonium nitrate, gas generating agent containing the same and production method thereof

(76) Inventor: Tadamasa Harada, Fujinomiya-shi (JP)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/145,795

(22) Filed: May 14, 2002

(30) Foreign Application Priority Data
May 14, 2001 (JP) P2001-143091

(51) Int. Cl. A01N 1/00

(52) U.S. Cl. 252/186.44

(57) ABSTRACT

An oxidized comprising a double salt represented by the chemical formula: M(NO₃)ᵢnNH₄NO₃. M is a metal element forming a nitrate salt usually containing water of crystallization, i is a numerical value corresponding to the valency of the metal element M, and n is a molar number from 1 to 20. Mixing a metal nitrate containing water of crystallization with ammonium nitrate , and, further drying produces the above-mentioned double salt.

### BACKGROUND OF THE INVENTION

1. Field of the Invention

The present invention relates to a gas generating agent used in an air bag apparatus for automobiles, a propelling apparatus using a gas, and a gas generating apparatus applied to high pressure installations and the like, more particularly, to a gas generating agent which provides little generation of an unfavorable gas, chemically stable, exhibits excellent gas generation efficiency, and can generate a gas at high speed.

2. Description of the Related Art

Solid gas generating agents are provided as a mixture of a fuel and an oxidizer or as a material having a fuel component and an oxidizer component together in its molecule. The proposed gas generating agents are used in an air bag apparatus for automobiles, a propelling apparatus utilizing a gas such as a rocket and the like, a pressure generating apparatus driving an automatic control apparatus, and the like.

These apparatuses are intensely required to be light and portable. Depending on use environments, it is expected that they could be exposed to high temperature and strong impact. Further, as a result of use, generation of an unfavorable gas should be particularly avoided. Therefore, gas generating agents used in these apparatuses are required to have properties that generation of an unfavorable gas is suppressed, the gas generation amount per unit weight or per unit volume is large, the gas generation speed is high, chemical stability against heat and impact is obtained, and the like.

For example, the unfavorable gas are nitrogen oxides, halogenated gases, carbon monoxide, high concentration carbon dioxide and so on. For suppression of generation of these gases, azide as main component has been proposed for air bag. However, sodium azide is unfavorable itself, and handling thereof needs particular attention.

In a propelling apparatus applied to a rocket, addition of ammonium perchlorate as an oxidizer is proposed. With this gas generating agent a hydrogen chloride gas is generated after burning. This gas possibly causes acid rain, and from the standpoint of care to environment, a gas generating agent containing no halogen is recently required.

As the gas generating agent containing no halogen, arts disclosed in WO95/19944 and WO96/20147 have been proposed. WO95/19944 discloses. as a gas generating agent, a complex salt composed of a ligand containing nitrogen, the coordination center made of a transition metal cation, and an anion containing oxygen. WO96/20147 discloses a compound Mg 3(H₃NCONH₃) 2(NO₃) as a fuel component.

### SUMMARY OF THE INVENTION

The gas generating agent disclosed by WO95/19944 is not approved as sufficient in the point of the generation amount of a gas per unit weight. The gas generation efficiency is calculated below, regarding the weight of a gas generated per unit weight as the gas generation efficiency. The reaction of generation of a gas from the gas generating agent disclosed by WO95/19944 is represented by the following reaction formula.

Cu(NH₃)₂(NO₂)₂→CuO+3H₂O+2N₂

Since 3 mol of water (molecular weight: 18) and 2 mol of nitrogen (molecular weight: 28) are generated as gases, from 1 mol of a gas generating agent having a molecular weight of 189, the gas generation efficiency is not more than about 60%.

In the case of the gas generating agent disclosed by WO96/20147, when KNO₃ is applied as an oxidizer, the reaction formula is represented by the following formula.

5{Mg3(H₃N₂CON₂H₃)2(NO₃)}+14KNO₃=45H₂O+27N₂+15CO₂+5MgO+7K₂O

The gas generation efficiency is likewise calculated to be about 72%, enhanced than that in the above proposed art.

However, in any of the above proposed arts, when a gas generating apparatus is operated at a low temperature of about −40° C. For example, it is observed that the volume of the generated gas is reduced. For example, when applied to an air bag for automobiles, sufficient inflation force may not be obtained.

The present invention has been accomplished to solve these problems of the proposed gas generating agents. The object thereof is to provide a gas generating agent which generates little unfavorable gas, stable at high temperature, exhibits excellent gas generation efficiency, and provides a tendency that the volume of a generation gas does not decrease easily even at lower temperature.

The inventor has investigated a cause for the phenomenon of reduction in the volume of a generated gas. In the case of the gas generating agents disclosed in WO95/19944and WO96/20147, the proportions of water molecules occupying in the generated gas are 60% and about 52% by molar ratio, respectively. It was found that when the gas generating apparatus is operated at lower temperature, a large amount of these water molecules become quickly to liquid water, and accordingly, the volume of a gas decreases.

As the oxidizer causing little generation of an unfavorable gas, nitrate compounds such as ammonium nitrate and metal nitrate may be applied. However, ammonium nitrate has low burning speed Further, since the metal nitrates contain a large amount of water of crystallization, they tend to be melted at higher temperature, together with the gas volume reduction at low temperature as described above.

The present invention has been accomplished in view of the above-mentioned investigations, and the present invention is composed of a double salt represented by the chemical formula:

M(NO₃)ᵢnNH₄NO₃

The above-mentioned M is usually a metal element forming a nitrate salt containing water of crystallization, the above-mentioned i is a numerical value corresponding to the valency of the metal element M, and the above-mentioned n is a molar number between 1 and 20.

M is preferably one or more metal elements selected from the group consisting of copper, magnesium, calcium, aluminum, nickel, cobalt and zinc.

The present invention is characterized in that a metal nitrate of M(NO₃)₁ is made into a double salt with ammonium nitrate, to exclude water of crystallization usually contained in a metal nitrate. A gas generating agent which generates little unfavorable gas, stable at high temperature, exhibits high gas generation efficiency, and provides a tendency that the volume of a generation gas does not decrease easily even at lower temperature has been actualized by addition of the above-mentioned double salt as an oxidizer to a gas generating agent.

### DETAILED DESCRIPTION OF THE INVENTION

As the stable metal nitrate containing water of crystallization, nitrate salts of copper, beryllium, magnesium, mercury, zirconium, bismuth, chromium, manganese, iron, nickel, cobalt and the like are exemplified. Preferable metal nitrates, which exhibit little metal toxicity and relatively cheap, are nitrate salts of copper, magnesium. calcium, aluminum, nickel, cobalt and zinc. Further, by use of a nitrate salt of magnesium and copper an oxidizer having further lower toxicity and very stable is obtained.

A suitable amount of ammonium nitrate is mixed per mol of the above-mentioned metal nitrate salt, to give a double salt or a complex salt. When the amount of ammonium nitrate is less than 1 mol, the gas generation efficiency decreases, and when over 20 mol, burning speed lowers . Therefore, ammonium nitrate in an amount of 1 to 20 mol, preferably 2 to 16 mol, further preferably 2 to 9 mol are mixed, to form a double salt or a complex salt.

When the above-mentioned ingredients are mixed, water of crystallization is substituted by ammonium nitrate and start to be liberated. When this is dried, liberation of water of crystallization of approximately the theoretical amount is completed, giving formation of solid. An oxidizer obtained as such does not contain water of crystallization, thereby it is stable even at higher temperature and is so oxidative as to increase the gas generation efficiency. Thus, such an oxidizer is suitable as a solid gas generating agent.

According to the present invention, two or more of the double salts having distinctive n values can be combined, and two or more of the double salts having distinctive M values can also be combined. Any of the double salts of the present invention is stable up to 200° C., and solid up to 120° C. Copper nitrate containing water of crystallization is melted at 114° C. and decomposed at 170° C., while the double salt of the present invention has excellent chemical stability at higher temperature.

Depending on the kind of M, or as single M can have different number of water of crystallization, the amount of water of crystallization contained in a metal nitrate varies. The amount of water of crystallization may not be particularly restricted. Those stable under synthesis environments can be used, for example, in the case of copper nitrate, a hexahydrate is stable at relatively lower temperature of 26° C. or lower, and a trihydrate is stable at relatively higher temperature of over 26° C.

When these metal nitrates and ammonium nitrate are mixed, water may be released to give viscous condition or slurry condition, or severe moisture absorption leading to poor handling, in some cases. In these cases, water may be added to prepare a solution to be mixed. This mixture is dried, and the drying conditions can be determined depending on the kind thereof. For example, if drying is effected only by heating, the heating temperature is from 60 to 150° C., preferably from 90 to 130° C. When unstable particularly at higher temperature, the temperature can be lowered by drying in vacuo.

An oxidizer composed of the above-mentioned double salt can be mixed with organic substances or nitrogen-containing organic substances to produce a self-burning solid and a solid gas generating agent. As the organic substances, to which a fuel and the like in general use may be applied, nonvolatile petroleum components, saccharose, sorbic acid and the like are exemplified. It is possible to use generally used polymer compounds such as polybutadiene, polypropylene glycol and the like having a hydroxyl group at the end, thermosetting type polymers having a prepolymer such as azide polymer and a hardening agent as the main components. To these compounds, for example, powders of aluminum, magnesium, boron and zirconium, nitramine compounds, for example, RDX, HMX and the like, can be added, to increase heat generation property to become high energy compound. As the organic substance used in the case of generation of a gas containing a nitrogen gas, there are typically listed compounds containing a triazole or tetrazole ring, for example, bitetrazole, 5-aminotetrazole and the like and guanidine derivatives, for example, aminoquanidine, nitroquianidine, dicyandiamide, guanidine nitrate and the like.

Of the above-mentioned organic substances, tetrazole derivatives are particularly suitable as a gas generating agent for air bags since they generate a large amount of nitrogen, exhibit little generation of CO₂ and H₂O, and generate a large amount of nitrogen. Of them, 5-aminotetrazole is highly stable and easy to be handled. A mixture of a double salt of copper nitrate and ammonium nitrate of the present invention with 5-aminotetrazole is not melted, even at 126° C. A gas generating agent composed of a mixture of 5-aminotetrazole and ammonium nitrate is melted at 100° C. to 110° C., therefore, the gas generating agent of the present invention is thermally more stable comparatively.

In the double salt of copper nitrate and ammonium nitrate of the present invention, when the amount of ammonium nitrate is in the range from 1 to 20 mol per mol of copper nitrate, heat absortion by a phase transition of ammonium nitrate from rhombic system to tetragonal system at 84° C. and another phase transition from tetragonal system to isometric system at 125° C. As not measured. Namely, It is suggested to be physically stable at higher temperature. When the amount of ammonium nitrate is large than the above-mentioned amount, the above-mentioned phase transition remains. In that case, a stabilizer for ammonium nitrate, for example, potassium nitrate, nickel oxide and the like may also be added for stabilization of phase. The above-mentioned disappearance of the phase transition of ammonium nitrate is a feature commonly recognized in double salts of the present invention including copper nitrate.

The burning speed of gas generating agent composed of the oxidizer of the present invention and organic substances, particularly composed of the double salt of copper nitrate and ammonium nitrate of the present invention and 5-aminotetrazole is higher than that of a composition with an ammonium nitrate single body and organic substance, and suitable for an inflator.

### EXAMPLE 1

Each seven kinds of metal nitrate hydrates shown in Table 1 was unsealed in a nitrogen box, and placed in suitable amount (about 1 to 5 g) into an agate mortar, and ground to size giving easy weighing. About 10 g of ammonium nitrate was likewise placed into an agate mortar and ground, then, passed through a 100 mesh sieve, then, dried at 70° C. to 1 hour or more, 6 mol of ammonium nitrate was mixed a metal nitrate hydrate, to produce 1.1 g of a composition. 1 g of this mixture was weighed into a weighing bottle and heated at 130° C. for 1 hour. After heating, this was cooled in air for several minutes, then, the weight was measured, further heated again for 1 hour, and weighed again to confirm no weight reduction is recognized. A difference in weight before and after this heating was divided by the initial weight, to calculate the weight reduction ratio. The results are shown in Table 1. The weight reduction ratio corresponds well to the theoretical content of water of crystallization. This shows that water of crystallization was liberated from the metal nitrate in the process of forming a double salt, and removed by the subsequently drying. The product was subjected to the elementary analysis. The quantification of metals was carried out by an energy dispersion type fluorescent X-ray analysis apparatus MESA 500 manufactured by Horiba Ltd. Nitrogen and hydrogen were quantified by a generally used differential method analyzer. Since oxygen is the residue of the above-mentioned elements, the amount thereof was calculated by subtracting the total amount of metals, nitrogen and hydrogen from 100. These analysis results are shown in Table 2. All of the amounts of nitrogen, hydrogen and oxygen corresponded to the theoretical amounts thereof in an ammonium nitrate double salt of a metal nitrate.

TABLE 1

| | | | WATER OF | |
|---|---|---|---|---|
| | | MOLECULAR | CRYSTALLIZATION | MASS LOSS |
| | METAL NITRATE | WEIGHT | (THEORETICAL) | (MEASURED) |
| 1 | Cu(NO₃)₂ 3H₂O | 241.6 | 22.4 | 23.5 |
| 2 | Mg(NO₃)₂ 6H₂O | 256.4 | 42.2 | 45.7 |
| 3 | Ca(NO₃)₂ 4H₂O | 236.1 | 30.5 | 32.3 |
| 4 | Al(NO₃)₃ 9H₂O | 375.1 | 43.2 | 44.5 |
| 5 | Nl(NO₃)₃ 6H₂O | 290.8 | 37.2 | 37.6 |
| 6 | Co(NO₃)₂ 6H₂O | 291.0 | 37.2 | 38.9 |
| 7 | Zn(NO₃)₂ 6H₂O | 297.5 | 36.3 | 38.3 |

TABLE 2

| | | | | ELEMENTAL CONTENT | | | | |
|---|---|---|---|---|---|---|---|---|
| | | MOLECULAR | | OF GAS (MASS %) | | | METAL ELEMENT | |
| | COMPOUNDS | WEIGHT | | N | H | O | SYMBOL | CONTENT |
| 1 | Cu(NO₃)₂6NH₄NO₃ | 667.8 | THEORETIC | 29.36 | 3.62 | 57.50 | Cu | 9.52 |
| | | | MEASURED | 29.1 | 3.5 | 58.2 | | 9.52 |
| 2 | Mg(NO₃)₂6NH₄NO₃ | 628.6 | THEORETIC | 31.20 | 3.85 | 61.09 | Mg | 3.87 |
| | | | MEASURED | 30.8 | 4.0 | 61.3 | | 3.87 |
| 3 | Ca(NO₃)₂6NH₄NO₃ | 644.3 | THEORETIC | 30.43 | 3.75 | 59.59 | Ca | 6.22 |
| | | | MEASURED | 30.1 | 3.5 | 59.1 | | 6.22 |
| 4 | Al(NO₃)₃6NH₄NO₃ | 693.3 | THEORETIC | 30.31 | 3.49 | 62.31 | Al | 3.89 |
| | | | MEASURED | 30.5 | 3.7 | 61.3 | | 3.89 |
| 5 | Nl(NO₃)₂6NH₄NO₃ | 663.0 | THEORETIC | 29.58 | 3.65 | 57.92 | Nl | 8.85 |
| | | | MEASURED | 29.8 | 3.5 | 57.4 | | 8.85 |
| 6 | Co(NO₃)₂6NH₄NO₃ | 663.2 | THEORETIC | 29.57 | 3.63 | 57.90 | Co | 8.89 |
| | | | MEASURED | 28.9 | 3.6 | 58.2 | | 8.89 |
| 7 | Zn(NO₃)₂6NH₄NO₃ | 669.7 | THEORETIC | 29.28 | 3.61 | 57.34 | Zn | 9.76 |
| | | | MEASURED | 29.4 | 3.9 | 56.9 | | 9.76 |

### EXAMPLE 2

1 to 60 mol of ammonium nitrate was added to each 1 mol of a copper nitrate trihydrate and a magnesium nitrate hexahydrate, and double salts were made according to the same manner, and conditions as Example 1. The weight reduction ratio was measured, and the Differential Scanning Calorimetry (DSC) of the product was measured by TOLEDO STAR SYSTEM manufactured by METLER, to confirm the presence of heat absorption by phase transition of ammonium nitrate at 84° C. The measurement results in the case of copper nitrate are shown in Table 3, and the measurement results in the case of magnesium nitrate are shown in Table 4. In any cases, the weight reduction ratio (shown in measured value column in Table 3 and Table 4) corresponded to the theoretical content of water of crystallization (shown in theoretical value column in Table 3 and Table 4). The heat absorption peak at 84° C. measured by DSC has disappeared, in the case of ammonium nitrate, in the range of from 1 to 20 mol (in Table 3, Cu 1 to Cu 13, in Table 4, Mg 1 to Mg 13), recognizing no occurrence of phase change. When the amount of ammonium nitrate exceeds 20 mol, the heat absorption peak at 84° C. is measured, and is undesirable. The results of measurement of heat weight loss with a copper nitrate and a sole magnesium nitrate are shown in Table 3 and Table 4 as comparative examples. The heat weight loss and the theoretical amount of water of crystallization of a copper nitrate trihydrate coincide within the range of experimental error, however, in the case of a magnesium nitrate hexahydrate, 33% of the theoretical water of crystallization amount remains though 67% weight reduction occurs. This coincides with Information described in Kagakudaijiten (Published by Tokyo Kagaku Dojin).

TABLE 3

| STARTING MATERIAL/ | MIXING | PRESENT INVENTION | | | | | | | | | | | | | | | | | COMPARATIVE |
|---|---|---|---|---|---|---|---|---|---|---|---|---|---|---|---|---|---|---|---|
| MOLECULAR WEIGHT | RATIO | Cu1 | Cu2 | Cu3 | Cu4 | Cu5 | Cu6 | Cu7 | Cu8 | Cu9 | Cu10 | Cu11 | Cu12 | Cu13 | Cu14 | Cu15 | Cu16 | Cu17 | EXAMPLE |
| Cu(No₃)₂ 3H₂O/ | WEIGHT | 15.11 | 60.15 | 50.15 | 43.01 | 37.64 | 33.41 | 30.13 | 23.19 | 20.30 | 37.74 | 15.87 | 14.36 | 13.11 | 10.06 | 7.94 | 5.69 | 4.39 | 100.0 |
| 241.6 | MOLE | 1.0 | 1.0 | 1.0 | 1.0 | 1.0 | 1.0 | 1.0 | 1.0 | 1.0 | 1.0 | 1.0 | 1.0 | 1.0 | 1.0 | 1.0 | 1.0 | 1.0 | — |
| NH₄NO₂/ | 24.89 | 39.85 | 49.85 | 56.99 | 62.36 | 66.53 | 69.87 | 76.81 | 79.90 | 82.26 | 64.13 | 85.64 | 86.69 | 89.94 | 92.06 | 94.31 | 95.21 | 0.00 | |
| 80.04 | MOLE | 1.0 | 2.0 | 3.0 | 4.0 | 5.0 | 6.0 | 7.0 | 10.0 | 12.0 | 14.0 | 16.0 | 18.0 | 20.0 | 27.0 | 35.0 | 50.0 | 60.0 | 0.00 |
| | SUM | 100.0 | 100.0 | 100.0 | 100.0 | 100.0 | 100.0 | 100.0 | 100.0 | 100.0 | 100.0 | 100.0 | 100.0 | 100.0 | 100.0 | 100.0 | 100.0 | 100.0 | 100.0 |
| WATER CONTENT | THEO. | 16.8 | 13.5 | 11.2 | 9.6 | 8.4 | 7.5 | 6.7 | 5.2 | 4.5 | 4.0 | 3.6 | 3.2 | 2.9 | 2.2 | 3.6 | 1.3 | 1.1 | 22.4 |
| (mass %) | ANAL. | 17.8 | 14.1 | 12.2 | 10.7 | 9.3 | 7.9 | 7.3 | 5.5 | 4.6 | 4.2 | 4.0 | 3.8 | 2.6 | 2.1 | 2.3 | 1.0 | 0.2 | 23.6 |

| | | | | | | | | | | | | | | | | | |
|---|---|---|---|---|---|---|---|---|---|---|---|---|---|---|---|---|---|
| HEAT ABSORPTION AT | None | None | None | None | None | None | None | None | None | None | None | None | None | Ob- | Ob- | Ob- | Ob- |
| 84° C. and 125° C. | | | | | | | | | | | | | | served | served | served | served |

TABLE 3

| STARTING MATERIAL/ | MIXING | PRESENT INVENTION | | | | | | | | | | | | | | | | | COMPARATIVE |
|---|---|---|---|---|---|---|---|---|---|---|---|---|---|---|---|---|---|---|---|
| MOLECULAR WEIGHT | RATIO | Mg1 | Mg2 | Mg3 | Mg4 | Mg5 | Mg6 | Mg7 | Mg8 | Mg9 | Mg10 | Mg11 | Mg12 | Mg13 | Mg14 | Mg15 | Mg16 | Mg17 | EXAMPLE |
| Mg(No₃)₂ 6H₂O/ | WEIGHT | 76.21 | 61.56 | 51.61 | 41.47 | 39.05 | 34.81 | 31.40 | 24.26 | 21.07 | 18.62 | 16.68 | 15.11 | 33.81 | 30.61 | 8.39 | 6.02 | 5.07 | 100.0 |
| 256.4 | MOLE | 1.0 | 1.0 | 1.0 | 1.0 | 1.0 | 1.0 | 1.0 | 1.0 | 1.0 | 1.0 | 1.0 | 1.0 | 1.0 | 1.0 | 1.0 | 1.0 | 1.0 | — |
| NH₄NO₃/ | 23.79 | 36.44 | 45.36 | 50.53 | 60.53 | 65.15 | 68.60 | 75.74 | 78.93 | 81.38 | 83.32 | 84.89 | 86.19 | 89.39 | 91.61 | 93.96 | 94.93 | 0.00 | |
| 80.04 | MOLE | 1.0 | 2.0 | 3.0 | 4.0 | 5.0 | 6.0 | 7.0 | 10.0 | 12.0 | 14.0 | 16.0 | 18.0 | 20.0 | 27.0 | 35.0 | 50.0 | 60.0 | 0.00 |
| | SUM | 100.0 | 100.0 | 100.0 | 100.0 | 100.0 | 100.0 | 100.0 | 100.0 | 100.0 | 100.0 | 100.0 | 100.0 | 100.0 | 100.0 | 100.0 | 100.0 | 100.0 | 100.0 |
| WATER CONTENT | THEO. | 32.1 | 26.0 | 21.8 | 18.8 | 16.5 | 14.7 | 13.2 | 10.2 | 8.9 | 7.9 | 7.0 | 6.4 | 5.8 | 4.5 | 3.5 | 2.5 | 2.1 | 42.1 |
| (mass %) | ANAL. | 33.3 | 27.1 | 22.5 | 19.6 | 17.2 | 15.0 | 14.1 | 10.8 | 9.2 | 8.3 | 7.4 | 6.6 | 6.1 | 4.9 | 3.7 | 2.8 | 2.2 | 27.7 |

| | | | | | | | | | | | | | | | | | |
|---|---|---|---|---|---|---|---|---|---|---|---|---|---|---|---|---|---|
| HEAT ABSORPTION AT | None | None | None | None | None | None | None | None | None | None | None | None | None | Ob- | Ob- | Ob- | Ob- |
| 84° C. and 125° C. | | | | | | | | | | | | | | served | served | served | served |

### EXAMPLE 3

The burning properties of gas generating agents obtained by combining double salts, which are produced by a copper nitrate trihydrate and ammonium nitrate and 5-aminotetrazole were evaluated. The measurement results of the gas composition after burning and the burning speed were shown In Table 5. In the column of the theoretical gas generation effectiveness in Table 5, the gas generation amounts are calculated by hypothesizing that hydrogen, nitrogen, carbon and copper become N₂, CO₂ and Cu₂O respectively by the burning reaction. The following experiment was carried out. by mainly selecting compositions in which the gas generation efficiency is 85% or more. Double salts were made according to the same method and same conditions as in Example 1. A powder of 5-aminotetrazole was prepared by grinding in a mortar and pressing through a 100 mesh sieve, and drying at 70° C. for 1 hour or more.

A gas generating agent having a composition shown in Table 5 was prepared and compressed to produced 15 tablets in the form of disk having a diameter of about 7 mm and a maximum thickness of about 1.5 mm, then, the thickness, diameter and weight of each tablets was measured. As an ignition agent, a mixture of 22% of boron and 78% of potassium nitrate was prepared.

For measurement of the burning speed, a pressure vessel having a capacity of about 52 ml provided with a safety valve, venting pipe with valve inner pressure measuring sensor and power source terminal, and a pressure measuring apparatus were prepared. Further, a detecting tube gas measuring apparatus manufactured by GASTECH and detecting tube thereof were prepared for measuring unpreferable trace gases in the generated gas, namely, NO, NO₂, NH₃ and CO. N₂ and CO₂ were measured by gas chromatography (column; UnibeaeDs C). Though H₂O is generated as a gas, the measurement thereof is impossible since it becomes liquid water in collecting, therefore, the theoretical value is used in the table. Further, hypothesizing that the value obtained by subtracting the theoretical value of water from 100 is the total amount of the generation amounts of N₂ and CO₂, this value was multiplied by the ratios of N₂ and CO₂ measured by gas chromatography to give the generation amount of N₂ and CO₂, respectively.

A nichrome wire having a diameter of about 0.4 mm was attached to the ignition power source terminal of the pressure vessel, and a pressure sensor was attached to a pressure sensor attaching pore, and the above-mentioned gas generating agent was filled around the nichrome wire. Hereinafter, the weight of the filled gas generating agent is represented by W. Into this was placed one tablet of the above-mentioned ignition agent and 100 mg of the ignition agent powder and the pressure vessel was closed, then, the valve of the venting pipe was closed, and the pressure sensor was connected to the pressure measuring apparatus, to enable measurement of pressure. Thereafter, electric power of about 30 volt AC was applied to the ignition power source terminal to ignite the gas generating agent. The relation of pressure and time was measured, and after completion of burning, the detecting tube gas measuring apparatus was attached to the venting pipe, the valve was opened and the gas concentration by the detecting tube was measured and a gas collected by a sample collecting apparatus was charged into gas chromatography, and the generation amounts of N₂ and CO₂ were measured. A series of measuring results are shown in Table 5. The pressure gradually increased with the lapse of time from the initial pressure (0.1 MPa), to reach to the maximum pressure (Pₘₐₓ) , then, reached to equilibrium. From the change in pressure by time, the burning speed in the close vessel test was calculated. The calculation was carried out, hypothesizing that all of the gas generating agent was burnt when the maximum pressure (Pₘₐₓ) was recorded. The value (P₁/Pₘₐₓ) obtained by dividing the pressure (P₁) at each time (T₁) by Pₘₐₓ corresponds to the ratio (W₁/W) of the amount (W₁) of the gas generating agent burnt until each time (T₁) to the gas generating agent total amount (W). Namely, the equation: P₁/Pₘₐₓ=W₁/W is satisfied. W₁ is calculated from these experimental values since P₁, Pₘₐₓ and W have been measured. Also the amount (Wᵣ) of the gas generating agent remaining at each time can be calculated since Wᵣ+W₁=W. When the initial diameter of the gas generating agent is represented by D₀, the thickness is represented by T₀, the burning distance burnt until each time (T₁) is represented by h₁, the density of the gas generating agent is represented by D, and the particle number of the gas generating agent is represented by n, the following relations are satisfied.

W=(π/4)×n×d×D₀²×T₀

Wᵣ=(π/4)×n×d×(D₀−2×h₁)²×(T₀−2×h₁)=W −W₁

therefore, the following relation is satisfied,

W₁/W=1−(Wᵣ/W) =1−(D₀−2×h₁)²×(T₀−2×h₁)/(D₀²×T₀)

Since other values than hits already known, hi can be calculated. For example, the burning speed at a pressure of 7 MPa is

(hᵢ₊₁−hᵢ)/(hᵢ₊₁−t₁)

when the time at a pressure of 6.8 MPa is Tᵢ, the burning distance at this time is hᵢ, the time at a pressure of 7.2 MPa is hᵢ+1, and the burning distance at this time is hᵢ+1. Thus, the burning speed at a pressure of 7 MPa was calculated. This result is described in the column of burning speed in Table 5. The gas generating agent of the present invention has the gas generation efficiency more excellent than conventional, and show the burning speed of 2 to 3-fold higher than comparative examples. Of unpreferable gases, the amount of a NO gas seems to be large. However, in the case of application to an air bag, when this gas is, released in a car room, it is diluted about 100-fold, providing no remarkable level.

As described above, comparison of the examples with the conventional examples recognized that the gas generating agent of the present invention shows little generation of an unfavorable gas, stable at higher temperature and gives higher gas generating efficiency. It was further recognized that due to little generation of H₂O, the volume of the generation gas does not decrease easily even at lower temperature.

TABLE 5

| | | | PRESENT INVENTION | | | | | | | | | | COMPARATIVE |
|---|---|---|---|---|---|---|---|---|---|---|---|---|---|
| | | | AC1 | AC2 | AC3 | AC4 | AC5 | AC6 | AC7 | AC8 | AC9 | AC10 | EXAMPLE |
| Oxidant | Cu(NO₃)₂ 3H₂O (molar ratio) | | 1.0 | 1.0 | 1.0 | 1.0 | 1.0 | 1.0 | 1.0 | 1.0 | 1.0 | 1.0 | 1.0 |
| | NH₄NO₃ (molar ratio | | 1.0 | 2.0 | 3.0 | 4.0 | 6.0 | 7.0 | 12.0 | 16.0 | 18.0 | 20.0 | 27.0 |
| | Cu(NO₃)₂ (mass %) | | 70.09 | 53.95 | 43.85 | 36.94 | 28.08 | 25.08 | 16.34 | 12.77 | 11.52 | 10.49 | 7.99 |
| | NH₄NO₃ (mass %) | | 29.91 | 46.05 | 45.15 | 63.06 | 71.92 | 74.92 | 83.66 | 87.23 | 88.48 | 89.51 | 92.01 |
| | Total amount | | 100.0 | 100.0 | 100.0 | 100.0 | 100.0 | 100.0 | 100.0 | 100.0 | 100.0 | 100.0 | 100.0 |
| Ingredient | Molecular weight | | 268 | 348 | 428 | 508 | 668 | 748 | 1148 | 1468 | 1628 | 1788 | 2349 |
| of gas | of the above mixture | | | | | | | | | | | | |
| generant | Oxidant content (mass %) | | 62.88 | 65.60 | 67.43 | 68.74 | 70.59 | 71.11 | 72.97 | 73.75 | 74.03 | 74.26 | 74.83 |
| | 5-aminotetrazole content | | 37.12 | 34.40 | 32.57 | 31.26 | 29.51 | 28.89 | 27.03 | 26.25 | 25.97 | 25.74 | 25.17 |
| | Gas generation effectiveness (%) | | 83.19 | 86.50 | 88.72 | 90.31 | 92.45 | 93.20 | 95.45 | 96.41 | 96.75 | 97.03 | 97.72 |
| | Gas generation mole number (mol/100g) | | 3.12 | 3.34 | 3.49 | 3.60 | 3.74 | 3.79 | 3.94 | 4.00 | 4.03 | 4.05 | 4.09 |
| | Calculated amount of Cu₂O generation (%) | | 16.81 | 13.50 | 11.28 | 9.69 | 7.55 | 6.80 | 4.55 | 3.59 | 3.25 | 2.97 | 2.28 |
| | Calculated amount of H₂O generation (%) | | 24.4 | 29.1 | 30.9 | 32.6 | 34.8 | 35.6 | 37.8 | 38.7 | 39.0 | 39.3 | 39.9 |
| Measured | Calculated amount of Co₂ generation (%) | | 21.6 | 19.8 | 18.9 | 16.3 | 16.0 | 15.4 | 15.1 | 13.7 | 13.5 | 13.4 | 13.0 |
| date | Calculated amount of N₂ generation (%) | | 54.0 | 51.1 | 50.2 | 51.1 | 49.2 | 49.0 | 47.2 | 47.6 | 47.5 | 47.3 | 47.1 |
| | Total amount of gases | | 100.0 | 100.0 | 100.0 | 100.0 | 100.0 | 100.0 | 100.0 | 100.0 | 100.0 | 100.0 | 100.0 |
| | Trace | NO (ppm) | 150 | 120 | 180 | 150 | 200 | 170 | 200 | 150 | 130 | 200 | 150 |
| | gases | No₂ (ppm) | 2 | 2 | 3 | 4 | 3 | 5 | 7 | 4 | 8 | 10 | 10 |
| | | NH₃ (ppm) | ND | ND | ND | ND | ND | ND | ND | ND | ND | ND | ND |
| | | CO (ppm) | ND | ND | ND | ND | ND | ND | ND | ND | ND | ND | ND |

| | | | | | | | | | | | |
|---|---|---|---|---|---|---|---|---|---|---|---|
| Burning speed at 7 MPA (mm/s) | 25.2 | 24.1 | 23.5 | 23.2 | 20.0 | 19.2 | 18.00 | 15.2 | 14.1 | 12.9 | 6.5 |

The contents of Japanese Patent Application No. 2001-143091 (filed on May 14, 2001) are incorporated herein by reference.

Although the invention has been described above by reference to certain embodiments of the inventions the invention is not limited to the embodiments described above. Modifications and variations of the embodiments described above will occur to those skilled in the art, in light of the above teachings.

What is claimed is:

1. A double salt represented by the chemical formula:
M(NO₃)ᵢnNH₄NO₃
wherein M is a metal element forming a nitrate salt hydrate;
i is a numerical value corresponding to the valency of the metal element m; and
a is a molar number from 1 to 20.

2. The double salt according to claim 1, wherein:
M is one or more metal elements selected from the group consisting of copper, magnesium. calcium, aluminum, nickel, cobalt and zinc.

3. The double salt according to claim 1, wherein:
n is a molar number from 2 to 16.

4. An oxidizer for gas generating agent, comprising:
the double salt according to claim 1.

5. A gas generating agent comprising:
a fuel; and
an oxidizer represented by the chemical formula:
M(NO₃)ᵢnNH₄NO₃
wherein M is a metal element forming a nitrate salt hydrate;
i is a numerical value corresponding to the valency of the metal element M; and
n is a molar number from 1 to 20.

6. The gas generating agent according to claim 5, wherein:
the fuel is composed of a nitrogen-containing organic substance.

7. The gas generating agent according to claim 6, wherein:
the nitrogen-containing organic substance is a tetrazole derivative; and
M is one or more metal elements selected from the group consisting of copper, magnesium, calcium, aluminum, nickel, cobalt and zinc.

8. A method of producing a double salt comprising:
mixing a metal nitrate hydrate with ammonium nitrate; and further drying.
